(19) United States
(12) Patent Application Publication
(10) Pub. No.: US 2014/0110342 A1
(43) Pub. Date: Apr. 24, 2014

(54) METHOD AND SYSTEM FOR MINIMIZING ENERGY CONSUMPTION DURING REVERSE OSMOSIS UNIT OPERATION

(71) Applicants: Senthilmurugan Subbiah, Tamilnadu (IN); Srinivas Mekapati, Andra Pradesh (IN); Kumar S. Mohan, Tiruvallur (IN)

(72) Inventors: Senthilmurugan Subbiah, Tamilnadu (IN); Srinivas Mekapati, Andra Pradesh (IN); Kumar S. Mohan, Tiruvallur (IN)

(73) Assignee: ABB RESEARCH LTD., Zürich (CH)

(21) Appl. No.: 14/116,051

(22) PCT Filed: Jun. 11, 2011
(86) PCT No.: PCT/IB2011/001316

§ 371 Date: Nov. 6, 2013

(30) Foreign Application Priority Data
Mar. 21, 2011 (IN) 861/CHE/2011

(51) Int. Cl. B01D 61/12

(52) U.S. Cl. CPC B01D 61/12
USPC 210/652; 210/137

(57) ABSTRACT

A method is disclosed for estimating an optimal individual product water flow rate for a RO train in an RO unit. The RO unit includes a plurality of RO trains. The method can include providing a desired overall product water flow rate for the reverse osmosis unit followed by obtaining one or more dynamic characteristics for each RO train in the plurality of RO trains; estimating a minimal specific energy consumption value for each RO train using the one or more dynamic characteristics; and subsequently obtaining an optimal individual product water flow rate for each RO train.

### TECHNICAL FIELD

The invention relates generally to a method and system for distributing reverse osmosis unit product water flow rates to individual reverse osmosis trains based on minimized specific energy consumption.

### BACKGROUND

Reverse Osmosis (RO) is a common technique used to purify water and other liquids industrially, wherein the feed liquid comprises solutes as impurities. It involves the use of at least one membrane, typically a series of membranes, and further a multiple set of series of membranes to retain the solutes to render the liquids pure. Each series of membranes is generally referred to in the art as “RO pressure vessel” and multiple pressure vessel combined unit is called as “RO trains”. In a typical liquid purification facility like an RO unit, several RO trains are connected in parallel, which are generally operated simultaneously to obtain purified liquid from all of the RO trains. The water is forced through the series of membranes under pressure to overcome the osmotic pressure. It is being used in various industries such as desalination, wastewater treatment and chemical manufacturing.

In a typical RO plant, high pressure is applied on the feed side of the membrane to overcome the osmotic pressure of the feed liquid and cause transport of the solvent from feed side to permeate side and allow the solute to accumulate near the membrane surface in a RO train. A portion of the feed liquid is also drained off, which is commonly referred to as reject stream or waste stream. The commonly found components of an RO plant include a feed source that provides the feed liquid along a feed line, a supply pump to force the feed liquid towards the RO trains, a high pressure pump to provide the necessary pressure to overcome the osmotic pressure, an energy recovery device to recover the energy from the reject stream, and a booster pump to provide this energy back into the feed line.

As a result of operation of the RO train, the concentration of the solute near the membrane surface increases gradually over a period, also referred to as fouling, which adversely affects the performance of the RO train. The rate of fouling is influenced by multiple factors such as changes in feed concentration, temperature, pressure, and the like, and it is difficult for the plant operator to determine the root cause for changing fouling rate in an RO train. Further, the fouling rate in a particular RO train will be different from the fouling rate in a different RO train, as the factors may be different at different RO trains. These factors include operating conditions, time and duration of membrane cleaning, and percentage of membranes replaced. The fouling rate has a direct bearing on the final product recovery from a RO plant.

Cleaning of RO trains to remove existing fouling may be undertaken, but it is not feasible to maintain the RO trains at a fouling level wherein the performance of the RO train is at a maximum. It is quite typical to maintain the performance of a RO train, and hence the entire RO plant at an optimum level instead of a maximum level, and schedule cleaning of RO trains only at certain fixed time schedules. In some situations, cleaning of fouled-up RO trains is effected only when the pressure drop between feed and reject exceeds a certain threshold value.

One common method of overcoming the reduction in product recovery due to fouling in a RO train is to increase the feed pressure, or the booster pressure or both. It would be obvious that as the extent of fouling increases with time, the amount of pressure required to push the liquid through the membrane increases. This leads to greater energy consumption in the operation of an RO train, which results in increased energy consumption for the RO plant on the whole. In such situations, some RO trains may be subjected to higher pressures than required for their operation, which may cause membrane damage. Thus, in a standard use case scenario, when the RO trains are fouled-up which has a marked impact on its product recovery, while at the same time not enough fouling to warrant cleaning and maintenance procedures, there is no available method for optimizing energy consumption for each RO train so as to enable more efficient operation while still retaining the total output from the RO plant as a whole.

### BRIEF DESCRIPTION

In one aspect, the invention provides a method for estimating an optimal individual product water flow rate for a RO train in an RO unit. The RO unit comprises a plurality of RO trains. The method comprises providing a desired overall product water flow rate for the reverse osmosis unit followed by obtaining one or more dynamic characteristics for each RO train in the plurality of RO trains. Dynamic characteristics of each RO train include various prevalent parameters relevant to the operation of the RO train, such as, but not limited to, pressure of high pressure pump, pressure of booster pump, feed liquid flow rate, feed flow rate to booster pump, extent of fouling, fouling rate, temperature of RO train, and the like, and combinations thereof. The method then involves estimating a minimal specific energy consumption value for each RO train using the one or more dynamic characteristics; and subsequently obtaining an optimal individual product water flow rate for each RO train. The optimal individual product water flow rate is obtained based on the corresponding minimal specific energy consumption value for all RO trains, wherein the sum of the optimal individual product water flow rate for each RO train yields the desired overall product water flow rate.

In another aspect, the invention provides a RO system comprising: a plurality of RO trains for receiving an overall input water to yield a product water, wherein the product water flow rate is characterized by a desired overall product water flow rate, and wherein each RO train of the plurality of RO trains is coupled to: an input source for input water, a high pressure pump for increasing an input pressure for the input water to yield a pressurized input water stream, a product outlet, and a waste outlet, wherein each RO train yields an optimal product water flow rate into the product outlet, and a reject stream into the waste outlet; and an optimizer module calculating the optimal individual product water flow rate for each RO train, wherein the optimal individual product water flow rate is based on the corresponding minimal specific energy consumption value for all trains, and wherein the sum of the optimal individual product water flow rate for each RO train yields the desired overall product water flow rate, the optimizer module further generates one or more set points for each RO train based on the optimal individual product water flow rate.

In yet another aspect, the invention provides a tool that uses the method of the invention.

In a further aspect, the invention provides a system that comprises the tool of the invention.

In a further aspect, the invention provides a unit that comprises the system of the invention.

### DRAWINGS

These and other features, aspects, and advantages of the present invention will become better understood when the following detailed description is read with reference to the accompanying drawings in which like characters represent like parts throughout the drawings, wherein:

FIG. 1 is a flowchart representation of exemplary steps involved in the method of the invention;

FIG. 2 shows a block diagrammatic representation of the system of the invention in one kind of configuration;

FIG. 3 shows a block diagrammatic representation of the system of the invention in another kind of configuration;

FIG. 4 shows the effect of varying reject water pressure and booster pump flow on the individual product water flow rate;

FIG. 5 shows the effect of varying the reject water pressure and booster pump flow on the specific energy consumption;

FIG. 6 shows a pareto-optimal set between the specific energy consumption and the individual product water flow rate for the given set of data points for the 3 RO trains in consideration in the example;

FIG. 7 shows a comparative example of operating an RO unit comprising 3 RO trains in current as-is scenario; and

FIG. 8 shows an exemplary situation of operating an RO unit wherein the individual product water flow rate is estimated using the method of the invention.

### DETAILED DESCRIPTION

As used herein and in the claims, the singular forms “a,” “an,” and “the” include the plural reference unless the context clearly indicates otherwise.

As used herein, the Reverse Osmosis (RO) means a filtration process that involves forcing a liquid through one or more membranes at a pressure, wherein the membrane is designed to allow only the liquid to flow through while retaining the solutes. Other filtration techniques, such as nanofiltration or microfiltration or ultrafiltration methods, also involve similar principles and consequently the methods and systems described herein, while described with respect to reverse osmosis, are applicable in these situations as well.

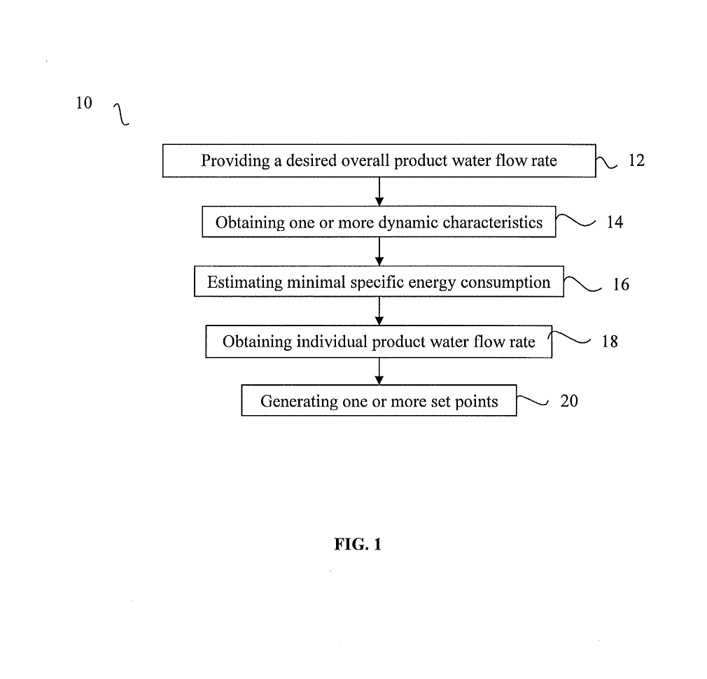

As noted herein the invention provides, in one aspect, a method for estimating an optimal individual product water flow rate for a RO train in a RO unit. As used herein, the phrase “RO plant” is also meant to encompass the phrase “RO unit”, and vice versa. FIG. 1 shows exemplary steps of the method of the invention 10 in a flowchart representation. The method comprises providing a desired overall product water flow rate for the reverse osmosis unit 12. The desired overall product water flow rate is a direct reflection of the productivity of the unit. It is measured in the form of standard units known to those of ordinary skill in the art, and may include, for example, litres/unit time, kilograms/unit time, kilolitres/unit time, tonnes/unit time, and the like. The overall product water flow rate is distributed among the RO trains in the RO unit. Each RO train consequently has an individual product flow rate that is expected as an output from it. In a standard RO unit, the desired overall product water flow rate is usually distributed equally among all the RO trains. However, as already noted, each RO train may be at different stages of fouling at a given point of time. Hence, equal distribution of desired overall product water flow rate is a highly inefficient and energy consuming method of distribution.

The method then comprises obtaining one or more dynamic characteristics for each RO train in the plurality of RO trains, depicted by numeral 14 in FIG. 1. Dynamic characteristics of each RO train include various prevalent parameters relevant to the operation of the RO train, such as, but not limited to, pressure of high pressure pump, pressure of booster pump, feed liquid flow rate, liquid feed flow rate to booster pump, extent of fouling, fouling rate, temperature of RO train, and the like, and combinations thereof. Some of these dynamic characteristics may be obtained through some measurement techniques using gadgets such as pressure sensors and thermometers. Other dynamic characteristics may be obtained from estimation techniques such as mathematical models applicable to the RO trains. In the case of the use of mathematical models, some kind of historical data may be necessary to estimate predicted values, such as fouling rates. Such models are known in the art, and are described in, for example, WO2009/104035 and references therein.

The method then involves estimating a minimal specific energy consumption value for each RO train using the one or more dynamic characteristics shown in FIG. 1 as numeral 16. In a RO train, and the RO unit as a whole, the energy consuming components may be identified in a facile manner by those skilled in the art. The method of the invention involves estimating the specific energy consumption by each RO train, as a combination of the energy consumed by the aforementioned identified components, which in some instances may be the sum of the energy consumed by the components per unit volume of product water produced. Subsequently, the method of the invention involves estimating the minimal specific energy consumption value for all RO train. This may be achieved by the use of pareto-optimal set between specific energy consumption and one or more dynamic characteristics subjected to constraints like limit on product concentration, recovery etc. In some embodiments, the optimization functions may be a polynomial functions. The optimization functions comprise constraints such as minimum and maximum bounds of certain dynamic characteristics, such as, for example booster pump pressure, feed flow rate, and the like. The optimization functions are designed to minimize the specific energy consumption while maximizing individual product output volume using appropriate mathematical methods, such as a multi-objective optimization technique. A polynomial function may be derived for each RO train. This estimation and derivation is repeated for all the RO trains in an RO unit.

With the above polynomial model equation the optimization problem for optimal load distribution between the RO trains is formulated as given below

$$Objective = {Minimize}_{Decision variables : \\ Product {flow}_{{Train}_{i}}} {\sum }_{i = 1}^{no RO train} {SEC}_{{Train}_{i}}$$

### Subject to

$${\sum }_{i = 1}^{no RO train} Product {flow}_{{Train}_{i}} = demand Flow$$

Lower limit_{Train}_{ₗ}≦Product flow_{Train}_{ₗ}≦Upper limit_{Train}_{ₗ}

where,

SEC_{Train}_{ₗ}=f(Product flow_{Train}_{ₗ},membrane fouling status)=f(Dynamic characteristics).

Product flow_{Train}_{ₗ} represents individual product water flow rate, and demand Flow represents desired overall product water flow rate. This step is represented by numeral 18 in FIG. 1 for the method of the invention.

Subsequently, the method represented by numeral 20 in FIG. 1 is used to generate one or more set points for the operation of each RO train based on the optimal individual product water flow rate obtained from step 18. The one or more set points include those required for the operation of the RO train which includes booster pump flow rate, reject stream pressure, high pressure pump speed, supply pump speed, and the like, and combinations thereof. These set points for each RO train are calculated using the optimization problem given below

$$Objective = {Minimize}_{Decision variables : \\ Operations set {points}_{{Train}_{i}}} SEC$$

### Subject to

Product concentration≦upper limit;
Concentration polarization or recovery≦upper limit (for membrane life improvement);
Membrane feed pressure≦upper limit;
Product flow rate=Optimal product flow (obtained from numeral 18);
Lower limit≦Operatinal set points≦Upper limit

In another embodiment, the optimization problems as described herein can be formulated into a single optimization problem as given below

$$Objective = {Minimize}_{Decision variables : \\ Product {flow}_{{Train}_{i}} \\ Operations set {points}_{{Train}_{i}}} {\sum }_{i = 1}^{no RO train} {SEC}_{{Train}_{i}}$$

Subject to
Product concentration_{Train}_{ₗ}≦Upper limit_{Train}_{ₗ}
Concentration polarization or Recovery_{Train}_{ₗ}≦Upper limit_{Train}_{ₗ}
Membrane feed pressure_{Train}_{ₗ}≦Upper limit_{Train}_{ₗ}
Lower limit_{Train}_{ₗ}≦Product flow_{Train}_{ₗ}≦Upper limit_{Train}_{ₗ}
Lower limit_{Train}_{ₗ}≦Operatinal set points_{Train}_{ₗ}≦Upper limit_{Train}_{ₗ}

The method of invention can be used as an off-line application wherein the optimization problem is solved separately using the necessary computing requirements, and subsequently, the solution applied to the operation of the RO unit. Alternately, the method of the invention may also be advantageously used as an on-line application, wherein the computing equipment required to solve the optimization problem is also connected to the RO unit. In another embodiment, the method of the invention also includes monitoring the dynamic characteristic of each RO train and estimating the minimal specific energy consumption for all trains, and accordingly, if necessary, adjusting the one or more set points dynamically to ensure minimization of energy consumption during the course of operation. One skilled in the art will recognize that operating an RO unit using the method of the invention will result in optimized energy consumption, thus resulting in considerable savings in costs while maintaining productivity and quality of product water.

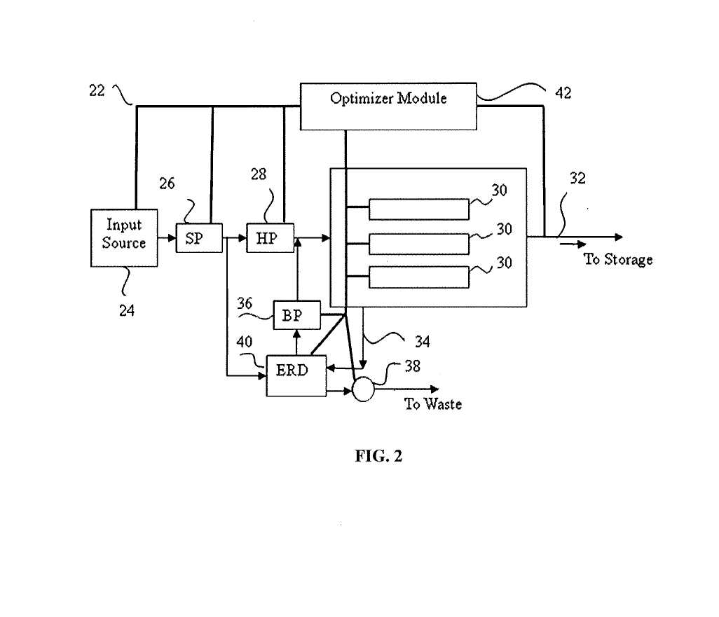

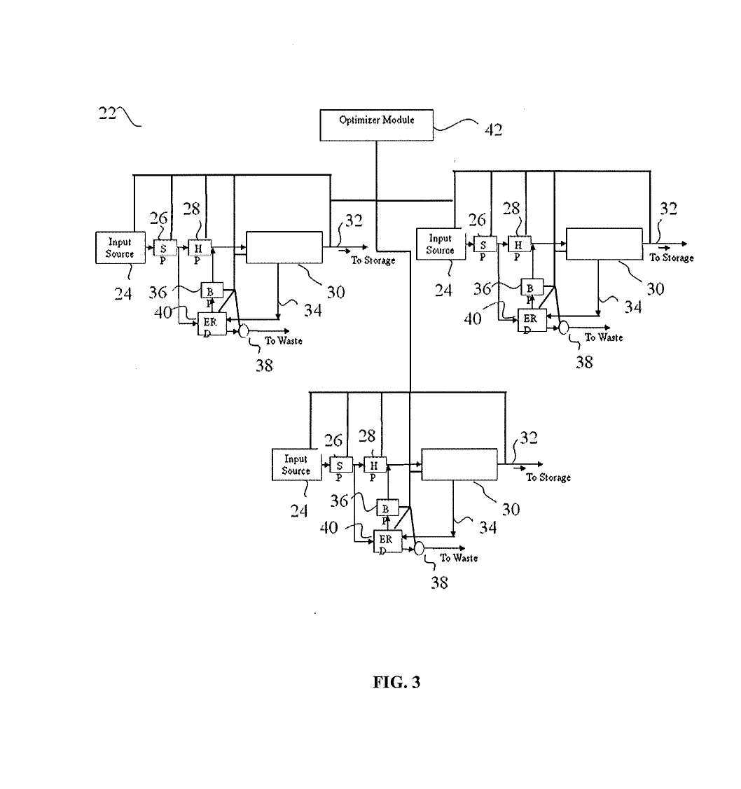

As noted herein, in another aspect the invention provides an RO system used to purify an input water. FIG. 2 shows a schematic of the RO system of the invention 22 configured in one kind of operation. FIG. 3 shows a schematic of the RO system of the invention 22 configured in another kind of operation, wherein a plurality of RO units are comprised within the system of the invention. The following description is given with respect to a single RO unit as part of the system of the invention for ease of explanation, however, one can easily extend this explanation the FIG. 3 as well. Other configurations may also be possible, and are contemplated to be within the scope of the invention.

The input water may be from any input source 24 such as sea water, brackish water, ground water, spent water from a processing unit, and the like. The RO system comprises a single or plurality of RO trains 30, that is used for the purification to yield a product water, wherein the product water flow rate is characterized by a desired overall product water flow rate. The input source is coupled to a supply pump 26, and a high pressure pump 28 for increasing an input pressure for the input water to yield a pressurized input water stream. The pressurized input water stream is then fed into the single or set of RO trains 30, which is then connected to a product outlet 32, and a waste outlet 34.

Further, the RO system 22 comprises a booster pump 36, a control valve 38 to control the flow of the reject stream, an energy recovering device 40 to recover energy from the reject stream. These components are well-known to one of ordinary skill in the art, and may be made available from a variety of commercial sources. Further, other components associated with a RO system may become obvious to one skilled in the art, and is contemplated to be encompassed within the scope of the invention. Such additional components may include, for example, sensors for pressure, temperature, flow rates, and the like, that may be placed at strategic locations along the flow lines, to obtain real time information of various parameters in the RO system.

Each RO train yields an optimal product water flow rate into the product outlet based on the functioning of an optimizer module 42 for estimating a minimal specific energy consumption value for all RO train using one or more dynamic characteristics for the RO train using the method of the invention. Subsequently the optimizer module 42 is also used to calculate the optimal individual product water flow rate for each RO train based on the corresponding to the minimal specific energy consumption value. It will be understood that the sum of the optimal individual product water flow rate for each RO train yields the desired overall product water flow rate.

The optimizer module 42 is also used to generate one or more set points for each RO train based on the optimal individual product water flow rate. The optimizer module 42 is shown in FIG. 2 to be connected to all of the components shown therein. The optimizer module is configured to accept inputs for the one or more dynamic characteristics, and then used to estimate the minimal specific energy consumption, followed by estimating the one or more set points. The optimizer module may be connected to any of the additional components, such as sensors, to obtain more real time inputs of the operation.

One skilled in the art will understand that it need not be connected to all of the components, or in some situations, none of the components at all. In the latter case, the dynamic characteristics are manually input or estimated through other means, and then used in the model to obtain the individual product water flow rate.

The optimizer module may be made available as a software on a hardware in the form of a distributed control system (DCS) or standalone software works with control system or other microprocessor based embedded systems. The optimizer module may be made available as a dedicated hardware or may be installed as a software tool on an existing programmable system, such as a computer with sufficient computing capabilities. Thus, in yet another aspect, the invention provides a tool that uses the method of the invention.

In a further aspect, the invention provides a RO unit that comprises the RO system of the invention as described herein.

### Example

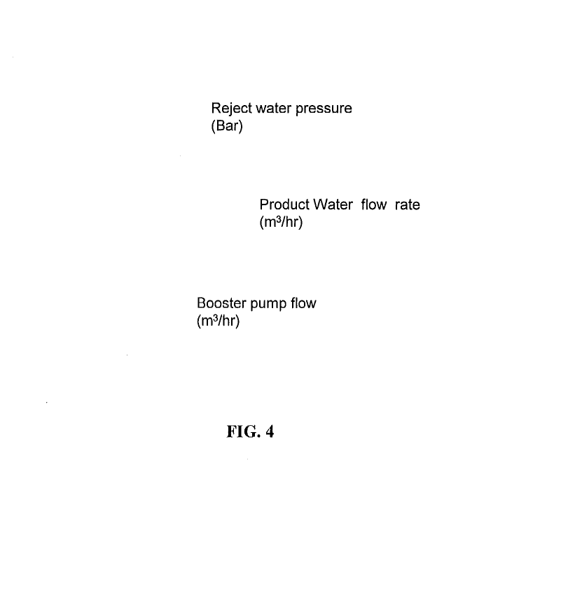

In one example, two dynamic characteristics reject water pressure and booster pump flow rate are used to optimize the productivity for a given desired overall product water flow rate in an RO unit comprising a set of 3 RO trains. FIG. 4 shows the effect of varying reject water pressure and booster pump flow on the individual product water flow rate. For operation of the RO unit, one of ordinary skill in the art will realize that it is advantageous to maximize the individual product water volume.

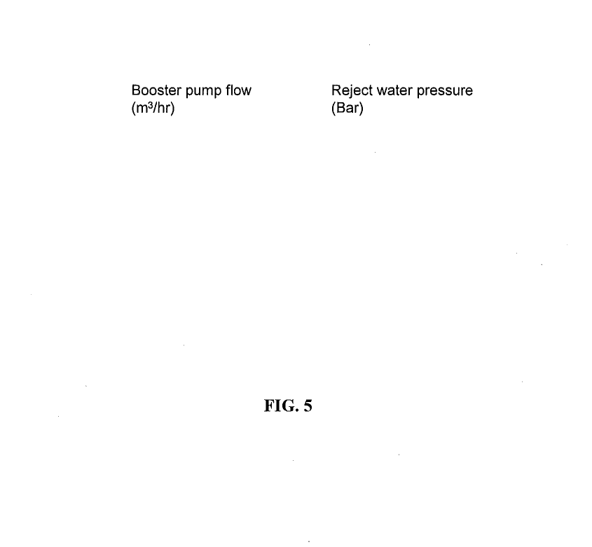

FIG. 5 shows the effect of varying the reject water pressure and booster pump flow on the specific energy consumption (abbreviated in FIG. 5 as SEC). Once again, one of ordinary skill in the art will understand maximizing the individual RO train product water flow rate may increase the combined specific energy consumption for three RO trains.

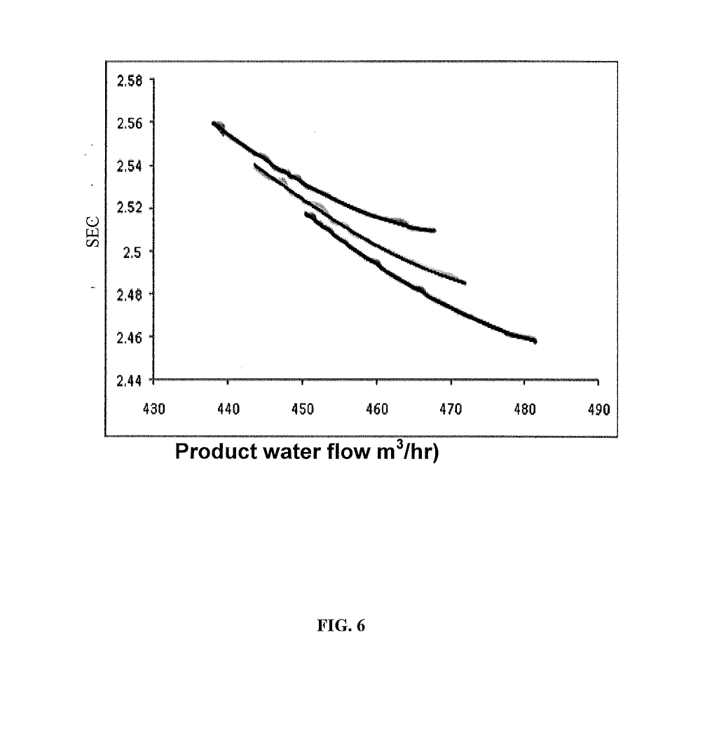

FIG. 6 shows a pareto-optimal set between the specific energy consumption and the individual product water flow rate for the given set of data points for the 3 RO trains in consideration in the example, wherein the top line is for an older and more used RO train, the lower line is for a newer and less used RO train, and the middle line is intermediate between the two RO trains. The specific energy consumption for the older RO train is greater than that for the others, which is reflected here in the graph.

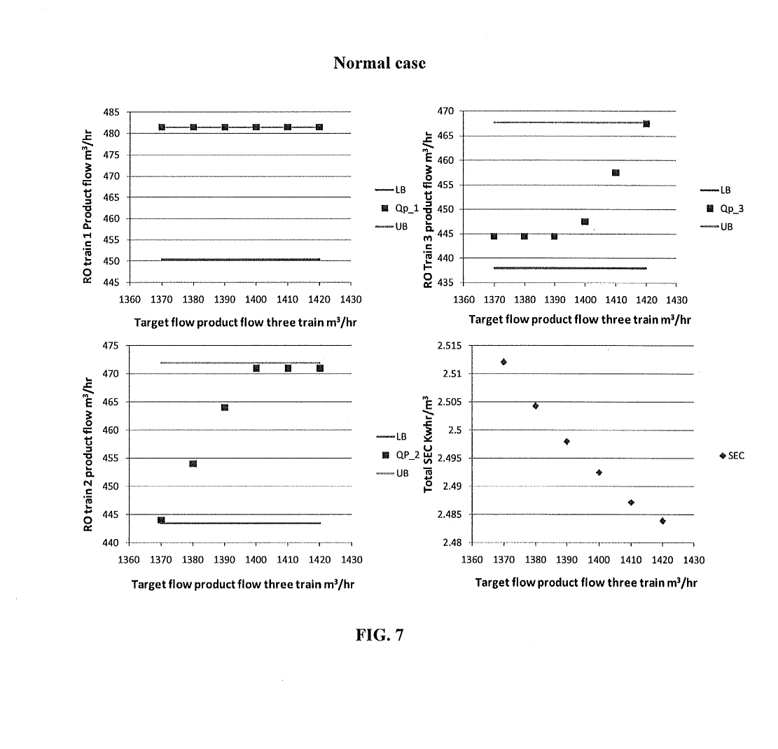

FIG. 7 shows a comparative example of operating an RO unit comprising 3 RO trains in current as-is scenario, wherein the individual product water flow rate from each RO train is given without optimization for minimal specific energy consumption of all three trains i.e. the RO train with newer membrane is loaded to its full capacity, RO train with older membrane is loaded to less capacity and RO train with intermediate membrane is loaded in-between to old and new membrane train capacity. Here, LB stands for Lower Boundary value for product flow rate, UB stands for upper boundary value for product flow rate. Qp_1, Qp_2 and Qp_3 stands for product water flow rate from RO train 1, RO train 2 and RO train 3, respectively. It can be seen that the specific energy consumption is considerably high.

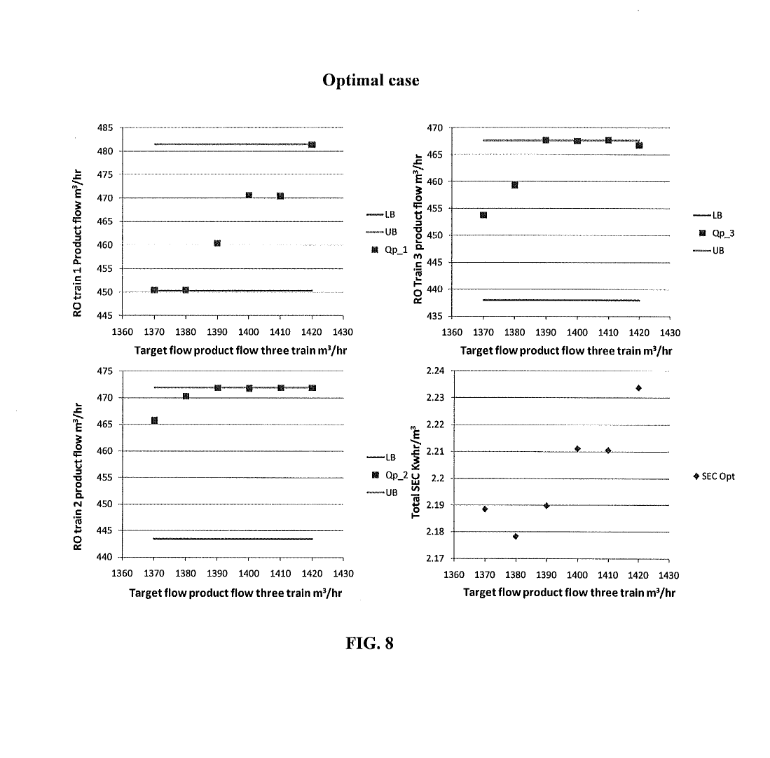

In direct contrast, FIG. 8 shows an exemplary situation of operating an RO unit wherein the individual product water flow rate is estimated using the method of the invention. It can be seen that the magnitude of the specific energy consumption, represented by SEC_{Opt} in the figure, is considerably lower than that of the corresponding values of as-is scenario in FIG. 7.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for estimating an optimal individual product water flow rate for a reverse osmosis (RO) train in a reverse osmosis unit, wherein the reverse osmosis unit includes a plurality of RO trains, the method comprising:
providing a desired overall product water flow rate for the reverse osmosis unit;
obtaining one or more dynamic characteristics for each RO train in the plurality of RO trains;
estimating a minimal specific energy consumption value for each RO train using the one or more dynamic characteristics; and
obtaining an individual product water flow rate for each RO train, wherein the optimal individual product water flow rate is based on a corresponding minimal specified energy consumption value for the RO train, wherein a sum of the individual product water flow rates for each of the plural RO trains yields the desired overall product water flow rate.

2. The method of claim 1, comprising:
obtaining the individual product water flow rate using an optimization procedure; and
generating one or more set points for each RO train based on the optimal individual product water flow rate.

3. The method of claim 2, wherein the one or more set points comprise a booster pump flow rate.

4. The method of claim 2, wherein the one or more set points comprise a reject stream pressure.

5. The method of claim 2, comprising:
dynamically adjusting, based on the one or more set points, at least one of a flow rate or an input pressure for each of an input water feed to each of the RO train.

6. The method of claim 2, comprising:
controlling energy consumption during operation, based on the one or more set points, in the RO unit.

7. The method of claim 1, comprising:
obtaining the one or more dynamic characteristics for each of the RO membranes from a model for the RO unit.

8. A tool for estimating an optimal individual product water flow rate for a reverse osmosis (RO) train in a reverse osmosis unit, wherein the reverse osmosis unit includes a plurality of RO trains, the tool comprising a control system with a computer programmed to perform the following in operation:
setting a desired overall product water flow rate for the reverse osmosis unit;
obtaining one or more dynamic characteristics for each RO train in the plurality of RO trains,
estimating a minimal specific energy consumption value for each RO train using the one or more dynamic characteristics; and
obtaining an individual product water flow rate for each RO train, wherein the individual product water flow rate is based on a corresponding minimal specified energy consumption value for the RO train, wherein a sum of the individual product water flow rates for each of the plural RO trains yields the desired overall product water flow rate.

9. A reverse osmosis system that comprises the tool of claim 8.

10. A reverse osmosis unit, in combination with the system of claim 9.

11. A reverse osmosis (RO) system comprising:
a plurality of RO trains for receiving an overall input water to yield a product water, wherein the product water is characterized by a desired overall product water flow rate, and wherein each RO train of the plurality of RO trains is coupled to:
an input source for input water;
a high pressure pump for increasing an input pressure for the input water to yield a pressurized input water stream;
a product outlet; and
a waste outlet;
wherein each RO train yields a desired product water flow rate into the product outlet, and a reject stream into the waste outlet; and
an optimizer module for estimating a minimal specified energy consumption value for each RO train using one or more dynamic characteristics for the RO train, and for calculating an individual product water flow rate for each RO train, wherein the optimal individual product water flow rate is based on a corresponding minimal specified energy consumption value, and wherein a sum of the individual product water flow rates for each of the plural RO trains yields the desired overall product water flow rate, the optimizer module being configured for generating one or more set points for each RO train based on the individual product water flow rate.

12. The RO system of claim 11, comprising:
a booster pump for providing a pressure boost for the reject stream to flow towards the pressurized input water stream, wherein the one or more set points includes a booster pump flow rate.

13. The RO system of claim 11, comprising:
a reject pressure valve for adjusting a reject pressure for the reject stream to make the reject stream flow upstream, and wherein the one or more set points includes a reject stream pressure.

14. The RO system of claim 11, wherein the individual product water flow rate is obtained using an optimization procedure of the optimizer module; and wherein the one or more set points are selected to dynamically adjust a flow rate or an input pressure at the high pressure pump.

15. The RO system of claim 11, comprising:
a model for the RO unit, wherein the one or more dynamic characteristics for each RO train is obtained from the model for the RO unit.

16. The RO system of claim 12, comprising:
a reject pressure valve for adjusting a reject pressure for the reject stream to make the reject stream flow upstream, and wherein the one or more set points includes a reject stream pressure.

17. The RO system of claim 16, wherein the one or more set points are selected to dynamically adjust a flow rate or an input pressure at the high pressure pump.

18. The RO system of claim 17, comprising:
A model for the RO unit, wherein the one or more dynamic characteristics for each RO train is obtained from the model for the RO unit.

19. The method of claim 5, comprising:
obtaining the one or more dynamic characteristics for each of the RO membranes from a model for the RO unit.

20. The method of claim 6, comprising:
obtaining the one or more dynamic characteristics for each of the RO membranes from a model for the RO unit.
